(19) United States
(12) Patent Application Publication
(10) Pub. No.: US 2007/0024887 A1
(43) Pub. Date: Feb. 1, 2007

(54) Image forming device, storage medium for storing a program, and image forming device control method

(75) Inventors: Kyoichiro Hayashi, Osaka (JP); Yasuhiko Kida, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 11/161,360

(22) Filed: Aug. 1, 2005

(51) Int. Cl. G06K 15/00

(52) U.S. Cl. 358/1.14

(57) ABSTRACT

An image forming device is disclosed which prevents the user from abandoning printed matter in a paper discharge tray when printing is executed by transmitting a print command from a terminal. The image forming device includes an identification unit, a determination unit, a decision unit, and a processing unit. The identification unit identifies a user who has transmitted a print command from a terminal. The determination unit determines whether or not printed matter produced based on a previous print command has been abandoned in the paper discharge tray. The decision unit sets a restriction on the execution of the print command transmitted by the user identified by means of the identification unit, based on the determination results from the determination unit. The processing unit processes the print command in accordance with the restriction set by the decision unit when the print command is transmitted from the terminal.

### BACKGROUND OF THE INVENTION

1 Field of the Invention

The present invention relates to an image forming device, and more particularly to an image forming device such as a printer, a multi-function device, or the like that receives print commands transmitted from a terminal to execute printing.

In addition, the present invention relates to a storage medium that stores a program that will be executed by the image forming device, and a control method.

2 Background Information

In recent years, a plurality of user terminals in an office or the like are connected to an image forming device by means of a network such as a LAN. In this environment, the image forming device can be made to print by sending a print command to the image forming device from a user's terminal without the user going to the image forming device and operating the operation panel of the image forming device.

However, because printing is possible without leaving one's terminal, a user may forget to retrieve the printed matter from the image forming device, or may abandon the printed matter in the paper discharge tray of the image forming device because retrieval is inconvenient.

Furthermore, when printed matter is abandoned in the paper discharge tray, another person's printed matter will be discharged on top of the printed matter that was abandoned, and separating one's printed matter from another person's printed matter will be difficult.

Accordingly, an image forming device is disclosed in Japanese Patent Application Publication No. H7-125911 which generates a warning signal if printed matter is left in the paper discharge tray for longer than a specified period of time in order to encourage the user to retrieve the printed matter.

However, the image forming device shown in Japanese Patent Application Publication H7-1225911 does not punish the user even if the warning signal is ignored and the printed matter is not retrieved. Even after a warning signal has been generated, the user is still able to use the image forming device as usual, and thus this image forming device is not very effective at preventing printed matter from being abandoned.

An object of the present invention is to provide an image forming device which prevents the user from abandoning printed matter in a paper discharge tray when printing is executed by transmitting a print command from a terminal. This invention addresses this object as well as other objects, which will become apparent to those skilled in the art from this disclosure.

### SUMMARY OF THE INVENTION

A image forming device according to the present invention comprises identification means, determination means, decision means, and processing means. The identification means identifies a user who has transmitted a print command from a terminal. The determination means determines whether or not printed matter produced based on the print command has been abandoned in the paper discharge tray. The decision means sets a restriction on the execution of the print command transmitted by the user identified by means of the identification means, based on the determination results from the determination means. The processing means processes the print command in accordance with the restriction set by the decision means when a print command is transmitted from a terminal.

The image forming device of the present invention manages whether or not each user has abandoned printed matter by comprising identification means and determination means. The determination whether or not printed matter has been abandoned may, for instance, be made by determining whether or not the printed matter has been left for more than a specified period of time after the printed matter has been discharge to the paper discharge tray.

The image forming device of the present invention may further comprise an operation panel for enabling input of printing instructions. Here, the restrictions set by the decision means will not execute a print command until a printing instruction has been input from the operation panel.

The image forming device of the present invention comprises a decision means that sets a restriction on the execution of print commands transmitted from each user's terminal based on the previous determination results from the determination means. The decision means sets the restriction on the execution of print commands from each user based on the status of abandoned printed matter by each user. In addition, the processing means will not process print commands except within the restrictions determined based on the status of abandonment. Examples of processing here include executing print commands within the restrictions, and deleting the print commands from memory without printing even though a print command has been received.

In addition, if the print command is awaiting execution and another print command is sent from another terminal, the restriction set by the decision means may give priority to executing the print command from the other terminal. Furthermore, the restriction set by the decision means may execute the print commands using monochrome printing. In addition, the restriction set by the decision means may execute the print command by printing with a resolution lower than the resolution of the associated image.

The decision means may set a restriction based on the number of times or frequency in which the determination means determines that the printed matter has been abandoned. Here, the restriction set by the decision means will not execute the print commands if the number of times that the printed matter is abandoned is greater than a predetermined number of times or if the frequency in which the printed matter is abandoned is greater than a predetermined frequency. Furthermore, the decision means may set the restriction based on the number of times or frequency in which in which the printed matter is abandoned in a previous predetermined period of time.

The storage medium of the present invention stores a program which is executed by a computer arranged in the image forming device, the program causing the computer to function as identification means, determination means, decision means, and processing means. The identification means identifies a user who has transmitted a print command from a terminal. The determination means determines whether or not printed matter produced based on the print command has been abandoned in the paper discharge tray. The decision means sets a restriction on the execution of the print command transmitted by the user identified by means of the identification means, based on the determination results from the determination means. The processing means processes the print command in accordance with the restriction set by the decision means when a print command is transmitted from a terminal.

The control method of an image forming device according to the present invention comprises an identification step, a determination step, a decision step, and a processing step. In the identification step, a user who has transmitted a print command from a terminal will be identified. In the determination step, whether or not printed matter produced based on the print command has been abandoned in the paper discharge tray will be determined. In the decision step, a restriction will be set on the execution of the print command transmitted by the user identified by means of the identification step, based on the determination results from the determination step. In the processing step, the print command will be processed in accordance with the restriction set in the decision step when a print command is transmitted from a terminal.

The image forming device of the present invention places a restriction on the execution of a print command transmitted from a terminal, based on the previous abandoned state of printed matter that was generated based on a print command sent from that terminal. Thus, abandoning printed matter will become inconvenient for the user because the effect of preventing abandonment of printed matter is significantly higher than simply generating a warning signal.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a functional block diagram showing the image forming device of the present invention;

FIG. 2 is a flowchart showing the order of processing print commands in the aforementioned image forming device; and

FIG. 3 is a schematic diagram showing the content recorded in the recording means of the aforementioned image forming device.

### DETAILED DESCRIPTION OF THE PREFERRED EMBODIMENTS

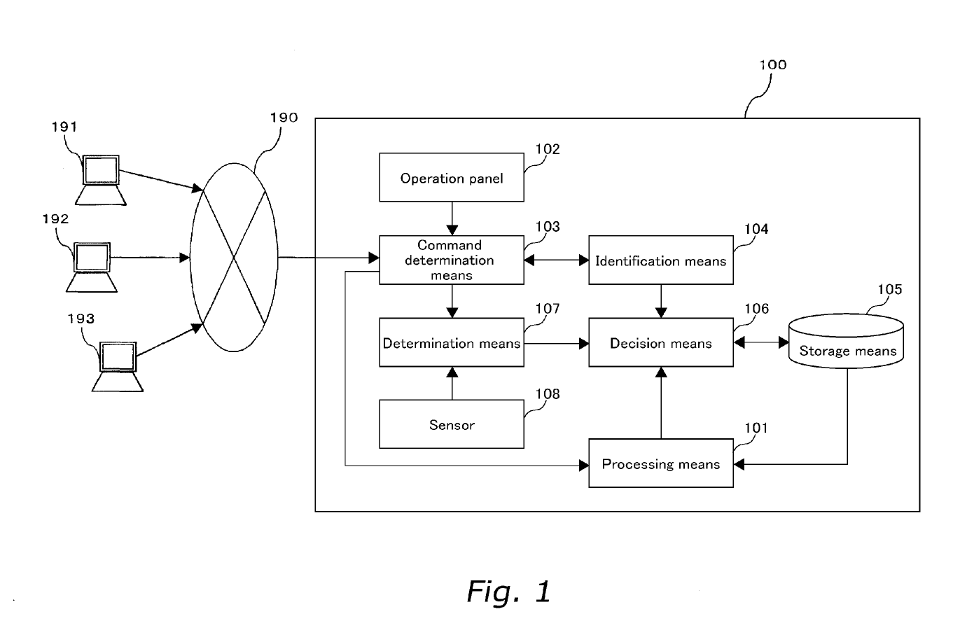

As shown in FIG. 1, an image forming device 100 is connected via a network 190 to terminals 191, 192, 193. The users of each of the terminals 191˜193 send various commands such as print commands via the network 190 to the image forming device 100 from each of the terminals 191˜193, and can thereby cause the image forming device 100 to execute print commands or the like.

The image forming device 100 comprises processing means 101 for processing commands such as print commands, copying commands, or fax transmission commands. This processing means 101 not only will process print commands, copying commands, or the like input from an operation panel 102 arranged on the image forming device 100, but also commands transmitted from the terminals 191˜193.

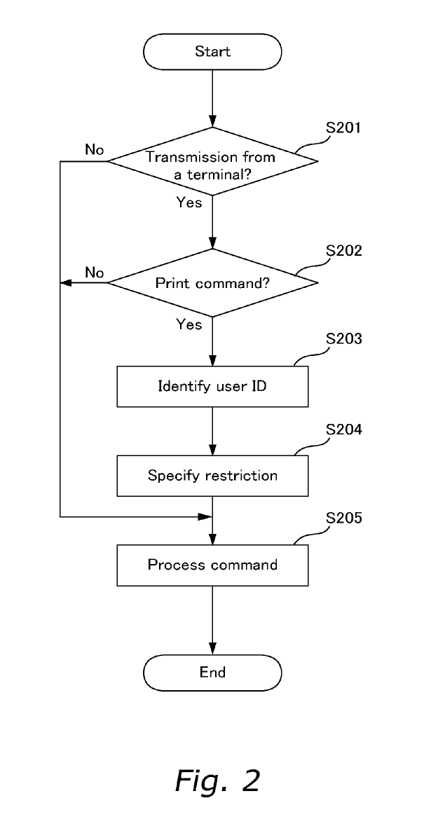

Commands which are transmitted from each of the terminals and commands which are input from the operation panel 102 are temporarily input to command determination means 103. The command determination means 103 determines whether the command that was input was input from the operation panel 102 or transmitted via the network 190, and determines whether or not the input command is a print command. More specifically, when a command is input, the command determination means 103 first determines whether the input command is input from the operation panel 102 or transmitted by the network 190 (S201 of FIG. 2).

The command determination means 103 will input the command to the processing means 101 if the input command was determined to be input from the operation panel 102. On the other hand, the command determination means 103 will also determine whether or not the command is a print command if the command was determined to be transmitted via the network 190 (S202 of FIG. 2). The command determination means 103 will input the command to the processing means 101 if the input command was determined to be a command other then a print command, such as for example a fax transmission command.

When a command is input from the command determination means 103, the processing means 101 will execute that command (S205 of FIG. 2). In this manner, commands other than print commands in which there is possibility that printed matter will be abandoned, and print commands entered from the operation panel 102 in which there is a low possibility that printed matter will be abandoned, will be executed.

The identification means 104 will identify the terminal 191˜193 as the source of the print command when the command determination means 103 determines in step 202 that the command is a print command. The identification means 104 will, more specifically, identify the user ID of the user who uses the terminal 191 if, for instance, terminal 191 was identified as the source of the print command (S203 in FIG. 2). Note that the mutual relationship between each of the terminals 191˜193 and the user ID of the users who use the terminals 191˜193 are pre-recorded in the identification means 104.

When the identification means 104 identifies a user ID, it will then enter the user ID identified to the command determination means 103. The command determination means 103 will input the user ID and the input print command into the processing means 101.

When a user ID and print command are entered, the processing means 101 will specify a restriction on the execution of print commands corresponding to the user ID which was entered (S204 of FIG. 2), will execute the print command in accordance with the specified restriction, or will delete the print command from memory without executing the print command (S205 of FIG. 2).

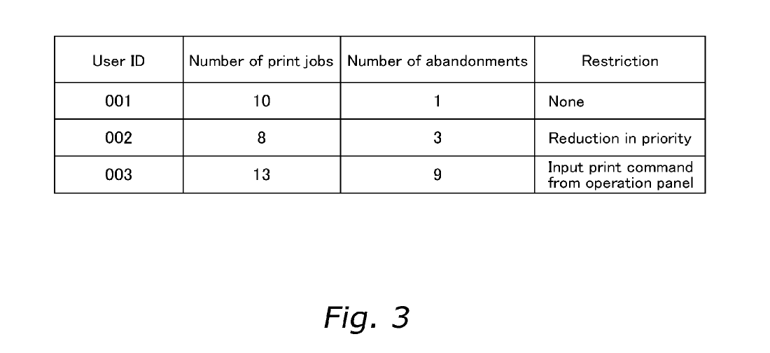

Restrictions on the execution of print commands are recorded in the recording means 105 as shown in FIG. 3.

Restrictions on the processing of print commands which are recorded in the recording means 105 are set by the decision means 106, and stored in the recording means 105.

When a print command is executed and printed matter is discharged to the paper discharge tray, the processing means 101 notifies the decision means 106 of the print command and the user ID which was input from the command determination means 103. When notified of the user ID, the decision means 106 adds 1 to the print job count corresponding to the user ID which was notified from the processing means 101 and recorded by the recording means 105. Next, the decision means 106 instructs the determination means 107 to detect any abandonment of printed matter. When instructed to detect for the abandonment of printed matter, the determination means 107 will measure the time that the printed matter is left in the paper discharge tray. Detection of whether or not printed matter has been left in the paper discharge tray is performed by a sensor 108, such as an optical sensor in which light is blocked by the printed matter discharged to the paper discharge tray, or a switch which is pressed down by the weight of printed matter which is discharged to the paper discharge tray.

The determination means 107 will detect abandonment when the printed matter is left in the paper discharge tray longer than a fixed period of time, and will not detect abandonment if that period of time is not exceeded. The determination means 107 notifies the decision means 106 of the results of whether or not abandonment has been detected.

If the notified detection results indicate abandonment, the decision means 106 adds 1 to the number of abandonments corresponding to the user ID which was notified from the processing means 101, and recorded by the recording means 105. The decision means 106 will leave the abandonment count as is if the notified detection results are that abandonment did not occur.

When the print job count or the abandonment count are updated by the notified detection results, the decision means 106 will determine the restriction corresponding to the user ID for which the print job count or the abandonment count has been updated.

These restrictions are decided, for instance, by the ratio of the abandonment count to the print job count, and if the percentage of abandonment is high, the restriction may be that the print command will not be executed, or that if the processing means 101 receives another command while the print command is awaiting execution, the other command will be executed with priority, or that the print command will not be executed until the user uses the operation panel 102 to reenter the print command transmitted from the terminal. Furthermore, examples of other restrictions include printing in monochrome regardless of the image of the document, or printing with a low resolution image.

In addition, if a restriction to not execute print commands is applied, print commands will never be executed, so when determining the restriction, the subject of the determination may be the ratio of the abandonment count to the print job count for the previous week or month, or the total abandonment count for the previous week or month.

In this manner, the processing means 101 will process the print command within the restrictions which are decided and stored in the recording means 105.

As shown above, if the printed matter is abandoned, restrictions will be applied to the execution of print commands, which will be inconvenient, and therefore users will not abandon printed matter.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

What is claimed is:

1. An image forming device, comprising:
identification means that will identify a user who has transmitted a print command from a terminal;
determination means that will determine whether or not printed matter produced based on a previous print command has been abandoned in the paper discharge tray;
decision means that will set a restriction on the execution of the print command transmitted by the user identified by means of the identification means, based on the determination results from the determination means; and
processing means that will process the print command in accordance with the restriction set by the decision means when the print command is transmitted from the terminal.

2. The image forming device according to claim 1, further comprising an operation panel capable inputting a print instruction;
wherein the restriction set by the decision means will not execute the print command until the printing instruction has been input from the operation panel.

3. The image forming device according to claim 1, wherein if a print command is awaiting execution and another print command is transmitted from another terminal, the restriction set by the decision means will give priority to executing the print command from the other terminal.

4. The image forming device according to claim 1, wherein the restriction set by the decision means will execute the print command with monochrome printing.

5. The image forming device according to claim 1, wherein the restriction set by the decision means will execute the print command by printing at a resolution lower than the resolution of the associated image.

6. The image forming device according to claim 1, wherein the decision means sets the restriction based on the number of times or frequency in which the determination means has determined that printed matter has been abandoned.

7. The image forming device according to claim 1, wherein the restriction set by the decision means will not execute the print command if the number of times in which printed matter has been abandoned is greater than a predetermined number of times, or if the frequency in which the printed matter is abandoned is greater than a predetermined frequency.

8. The image forming device according to claim 7, wherein the decision means will set the restriction based on the number of times or frequency in which printed matter was abandoned in a previous predetermined period of time.

9. A storage medium that stores a program which is executed by a computer arranged in an image forming device, the program causing the computer to function as:
identification means that will identify a user who has transmitted a print command from a terminal;
determination means that will determine whether or not printed matter produced based on a previous print command has been abandoned in the paper discharge tray;
decision means that will set a restriction on the execution of the print command transmitted by the user identified by means of the identification means, based on the determination results from the determination means; and
processing means that will process the print command in accordance with the restriction set by the decision means when the print command is transmitted from the terminal.

10. A control method for an image forming device, comprising the steps of:
identifying a user who has transmitted a print command from a terminal;
determining whether or not printed matter produced based on a previous print command has been abandoned in the paper discharge tray;
setting a restriction on the execution of the print command transmitted by the user identified by means of the identification step, based on the determination results from the determination step; and
processing the print command in accordance with the restriction set by the decision step when the print command is transmitted from the terminal.
